(19) United States
(12) Patent Application Publication
(10) Pub. No.: US 2025/0117734 A1
(43) Pub. Date: Apr. 10, 2025

(54) METHOD AND APPARATUS FOR TARGET BUSINESS MODEL GENERATION AND DATA PROCESSING BASED ON LARGE MODEL

(71) Applicant: BAIDU ONLINE NETWORK TECHNOLOGY (BEIJING) CO., LTD., Beijing (CN)

(72) Inventor: Bolei HE, Beijing (CN)

(73) Assignee: BAIDU ONLINE NETWORK TECHNOLOGY (BEIJING) CO., LTD., Beijing (CN)

(21) Appl. No.: 18/983,968

(22) Filed: Dec. 17, 2024

(30) Foreign Application Priority Data
Sep. 18, 2024 (CN) 202411302931.7

(51) Int. Cl. G06Q 10/067; G06N 3/096

(52) U.S. Cl. CPC G06Q 10/067; G06N 3/096

(57) ABSTRACT

Method and apparatus for target business model generation and data processing based on large language model are disclosed, which relates to the field of artificial intelligence technology, specifically in the areas of intelligent office, big data, and large models. A method for generating a target business model based on large language model includes: performing knowledge distillation on at least two pre-trained large models to obtain a base model of a target scenario, wherein each pre-trained model corresponds to one of at least two business types included in the target scenario; performing knowledge distillation on the base model to obtain a target business model of a target business type among the at least two business types, wherein the target business model is used for processing data of the target business type.

The present application claims the priority of Chinese Patent Application No. 202411302931.7, filed on Sep. 18, 2024, with the title of “Method and Apparatus for Target business Model Generation and Data Processing Based on Large Model”. The disclosure of the above application is incorporated herein by reference in its entirety.

### FIELD OF THE DISCLOSURE

The present disclosure relates to the field of artificial intelligence technology, specifically in the areas of intelligent office, big data, and large models. In particular, the present disclosure relates to method and apparatus for target business model generation and data processing based on large model.

### BACKGROUND OF THE DISCLOSURE

Currently, with the rapid development of artificial intelligence technology, a Large Language Models (LLMs, hereinafter referred to as large models) are widely applied in various scenarios.

In enterprise office scenarios, the efficient and cost-effective application of large models remains a challenge to be addressed.

### SUMMARY OF THE DISCLOSURE

The present disclosure provides method and apparatus for target business model generation and data processing based on large language model.

According to one aspect of the present disclosure, a method for generating target business model based on large language model is provided, including: performing knowledge distillation on at least two pre-trained large models to obtain a base model of a target scenario, each pre-trained model corresponding to one of at least two business types included in the target scenario; performing knowledge distillation on the base model to obtain a target business model of a target business type among the at least two business types, the target business model being used for processing data of the target business type.

According to another aspect of the present disclosure, a method for data processing is provided, including: obtaining target data of a target business type; processing the target data using a target business model corresponding to the target business type to obtain a processing result; wherein the target business model is generated using any of the methods described above.

According to another aspect of the present disclosure, there is provided an electronic device, including: at least one processor; and a memory communicatively connected with the at least one processor; wherein the memory stores instructions executable by the at least one processor, and the instructions are executed by the at least one processor to enable the at least one processor to perform a method for generating a target business model based on large model, wherein the method for generating a target business model based on large model includes: performing knowledge distillation on at least two pre-trained large models to obtain a base model of a target scenario; each pre-trained large model corresponding to one of at least two business types included in the target scenario; performing knowledge distillation on the base model to obtain a target business According to one aspect of the present disclosure, model of a target business type among the at least two business types; the target business model being used for processing data of the target business type.

According to another aspect of the present disclosure, there is provided a non-transitory computer readable storage medium with computer instructions stored thereon, wherein the computer instructions are used for causing a method for generating a target business model based on large model, wherein the method for generating a target business model based on large model includes: performing knowledge distillation on at least two pre-trained large models to obtain a base model of a target scenario, each pre-trained large model corresponding to one of at least two business types included in the target scenario; performing knowledge distillation on the base model to obtain a target business model of a target business type among the at least two business types, the target business model being used for processing data of the target business type.

It should be understood that the content described in this section is not intended to identify key or essential features of the embodiments of the present disclosure, nor is it intended to limit the scope of the present disclosure. Other features of the present disclosure will become readily apparent through the following detailed description.

### BRIEF DESCRIPTION OF DRAWINGS

The drawings are used for a better understanding of this solution and do not constitute limitations of the present disclosure. In the drawings:

FIG. 1 is a schematic diagram according to the first embodiment of the present disclosure;

FIG. 2 is a schematic diagram of the application scenario used to implement the embodiments of the present disclosure;

FIG. 3 is a schematic diagram according to the second embodiment of the present disclosure;

FIG. 4 is a schematic diagram of the first stage of knowledge distillation according to an embodiment of the present disclosure;

FIG. 5 is a schematic diagram of the second stage of knowledge distillation according to an embodiment of the present disclosure;

FIG. 6 is a schematic diagram according to the third embodiment of the present disclosure;

FIG. 7 is a schematic diagram according to the fourth embodiment of the present disclosure;

FIG. 8 is a schematic diagram according to the fifth embodiment of the present disclosure;

FIG. 9 is a schematic diagram of the electronic device implementing the method for target business model generation or data processing based on large model.

### DETAILED DESCRIPTION OF PREFERRED EMBODIMENTS

The following describes exemplary embodiments of the present disclosure in conjunction with the drawings, including various details of the disclosed embodiments to facilitate understanding. These should be considered merely exemplary. Therefore, those skilled in the art should recognize that various changes and modifications can be made to the described embodiments without departing from the scope and spirit of the present disclosure. Similarly, descriptions of known functions and structures are omitted for clarity and conciseness.

In vertical-domain scenarios, a pre-trained large language model is typically fine-tuned to obtain a fine-tuned model corresponding to the vertical domain, and the fine-tuned model is used for inference.

Enterprise office scenarios are different from vertical-domain scenarios. While vertical-domain scenarios usually focus on processing single-type data (such as code generation), enterprise office scenarios face multiple business types, including customer service dialogue, enterprise document processing, intelligent recommendations, etc. If each business type is fine-tuned to the pre-trained large model to obtain the corresponding type of the fine-tuned model, there will be problems such as high computational resource overhead and complex deployment.

Therefore, in the context of enterprise office scenarios, there is a need to efficiently and cost-effectively obtain a target model suitable for the target business type.

In order to efficiently and cost effectively obtain a model suitable for enterprise office scenarios, the present disclosure provides the following embodiments.

FIG. 1 is a schematic diagram according to the first embodiment of the present disclosure. This embodiment provides a method for generating a target business model based on large model. As shown in FIG. 1, the method includes:

101: Performing knowledge distillation on at least two pre-trained large models to obtain a base model of a target scenario; each pre-trained large model corresponding to one of at least two business types included in the target scenario.

102: Performing knowledge distillation on the base model to obtain a target business model of a target business type among the at least two business types; the target business model being used for processing data of the target business type.

In this method, a pre-trained large model refers to an existing model obtained through pre-training.

In this embodiment, processing is performed based on multiple (at least two) pre-trained large models.

These pre-trained large models may include: GPT-o, GPT-4, EB4, Qwen3.5, etc. GPT-o and GPT-4 are models from one of the Generative Pre-trained Transformer (GPT) series respectively. The EB4 is a model from the ERNIE Bot series. The Qwen3.5 is a model from the Qwen series.

The core idea of knowledge distillation is to use a complex model (teacher model) that has already been trained to guide the training of a simple model (student model), so that the performance of the student model is close to that of the teacher model, while the number of parameters is significantly reduced.

In the first stage, the pre-trained large model serves as the teacher model, and the base model of the target scenario serves as the student model. Through knowledge distillation, the base model of the target scenario is generated from multiple existing pre-trained large models.

The target scenario refers to the scenario where the model is to be applied, and involves multiple business types.

Taking the target scenario of an enterprise office as an example, multiple business types are involved, such as customer service dialogue, enterprise document processing, intelligent recommendations, etc.

If the pre-trained large model is fine-tuned for each business type to obtain the corresponding business model, there will be problems such as poor efficiency and high cost.

Therefore, in this embodiment, a base model shared by different business types is first obtained based on a pre-trained large model, and then business models corresponding to respective business types are obtained based on the base model.

Since the base model is shared among different business types, it needs to have a certain degree of generalization capability to meet the data processing requirements of different business types.

To ensure the generalization capability of the base model, knowledge distillation is performed on multiple pre-trained large models to learn knowledge from each pre-trained model, enhancing the base model's generalization capability.

The multiple pre-trained models correspond to different business types respectively, which is beneficial for the base model to learn knowledge from different business types.

For instance, if the target scenario includes three business types (such as customer service dialogue, enterprise document processing, and intelligent recommendations in an enterprise office scenario), three pre-trained large models can be selected, each corresponding to one of the above three business types respectively. For example, since Qwen3.5 has strong dialogue capabilities, then this pre-trained large model can serve as the corresponding pre-trained model of the business type of the customer service dialogue.

In this way, the base model can learn different knowledge from pre-trained large models corresponding to different business types, improving its generalization capability and accuracy of these models.

After obtaining the base model, a knowledge distillation can also be used to distill the base model of the target scenario to obtain a target business model of the target business type in the target scenario.

That is, in the second stage, the base model serves as the teacher model and the target business model serves as the student model. Through the knowledge distillation, the target business model is generated from the base model.

The target business type refers to one or more of the multiple business types included in the target scenario.

For example, the base model can be subjected to knowledge distillation using samples corresponding to the first business to obtain a first business model. This first business model is used for the inference process of the first business type. Specifically, if the first business type is customer service dialogue, then a first business model of customer service dialogue is generated. And in the inference stage, the customer service dialogue can be conducted using the first business model. Another example is using samples corresponding to the second business type to perform knowledge distillation on the base model to obtain a second business model, which is used for inference processes of the second business type. Specifically, if the second business type is enterprise document processing, then a second business model of enterprise document processing is generated, which is used during the inference stage for enterprise document processing, such as document classification, document summary generation, etc.

Through the process of knowledge distillation, a student model with a smaller scale compared to the teacher model can be obtained, which however can maintain the performance of the teacher model, thus obtaining a model with better performance and smaller scale.

In the model application stage, this target business model can be used for inference, such as processing business data of types like text, images, Application Programming Interface (API), etc., to obtain accurate and efficient data processing results.

In this embodiment, the base model of the target scenario is obtained by performing knowledge distillation on the pre-trained large models, and then the target business model of the target business type is obtained by performing knowledge distillation on the base model, which can generate the target business model cost-effectively and efficiently. In addition, by performing knowledge distillation on multiple pre-trained large models to obtain the base model, with each pre-trained large model corresponding to a business type, the base model can learn knowledge from different business types, which improves the generalization capability and accuracy of the base model, and thereby improves the accuracy of the target business model.

In practical implementation, the model generation method and the data processing method based on the generated target business model can be executed by physical devices, which can be terminal devices, servers, processing units, etc. Since the target business model is obtained through two stages of knowledge distillation, the target business model has a smaller scale, occupies fewer resources, and can also improve data processing efficiency due to its smaller scale. This saves storage resources and computational resources of the physical device, improves processing speed, and enhances the internal performance of the physical device.

Taking text data as an example, the following approach can be used to obtain a target business model applicable to text data:

Based on the first text data sample, knowledge distillation is performed on at least two pre-trained large models to obtain a base model of a target scenario; Each pre-trained large model corresponding to one of at least two business types included in the target scenario.

Based on the second text data sample, knowledge distillation is performed on the base model to obtain a target business model of a target business type among the at least two business types; The target business model being used for processing data of the target business type.

In this method, the first text data sample includes: text data samples corresponding to the at least two business types; The second text data sample includes: text data samples corresponding to the target business type.

Specifically, in the first stage: assuming the target scenario involves two business types, namely customer service dialogue and document processing, then a pre-trained large model suitable for customer service dialogue can be selected as the first pre-trained model, and a model suitable for document processing can be selected as the second pre-trained model. Specifically, since Qwen3.5 has strong dialogue capabilities, it serves as the first pre-trained model. And since EB4 has strong document processing capabilities, such as document classification, EB4 serves as the second pre-trained model.

In addition, samples of various business types can be collected as the first text data sample, for example, collecting existing dialogue data samples and document classification samples to form the first text data sample.

After determining the first and second pre-trained models and obtaining the first text data sample, the first text data sample is input into the above two pre-trained models respectively, as well as into the base model to be trained. These models process the first text data, such as extracting features and generating data or classification based on the extracted features, to obtain corresponding output results. For example, the first pre-trained model produces the first dialogue prediction result, the second pre-trained model produces the first document processing prediction result, and the base model produces prediction results corresponding to multiple business types, which are respectively called the second dialogue prediction result and the second document processing prediction result. These dialogue prediction results and document processing prediction results are all text data. Subsequently, a first loss function can be constructed based on the first and second dialogue prediction results, a second loss function based on the first and second document processing prediction results. The sum of the first and second loss functions serves as the loss function of the first stage. And the parameters of the base model can be adjusted using this loss function until a preset ending condition is met, resulting in the final base model.

In this process, text data and its processing are involved. Since it involves multiple pre-trained large models corresponding to different business types to process text data, and the base model obtains text prediction results corresponding to multiple business types, a base model adapted to process text data of multiple business types can be obtained to improve the base model's accuracy and generalization capability for text data of multiple business types.

In the second stage: assuming the target business type is customer service dialogue, existing dialogue data samples can be collected as the second text data sample. This second text data sample is input into both the base model obtained from the first stage, as well as into the target business model to be trained corresponding to the customer service dialogue. The base model and the target business model process the second text data, such as extracting text features from the second text data and generating dialogues based on the extracted text features, to obtain corresponding output results. For example, the base model produces the third dialogue prediction result, and the target business model obtains the fourth dialogue prediction result. These dialogue prediction results are all text data. Subsequently, a loss function for the second stage can be constructed based on the third and fourth dialogue prediction results. This loss function is used to adjust the parameters of the target business model until a preset ending condition is met, resulting in the final target business model. When applied, this target business model is used for customer service dialogue.

In this way, by using the second text data sample (dialogue data sample) for text data generation and other processing, a target business model suitable for customer service dialogue can be obtained, improving the accuracy of this target business model.

To better understand the present disclosure, the application scenarios involved in the present disclosure are explained as follows:

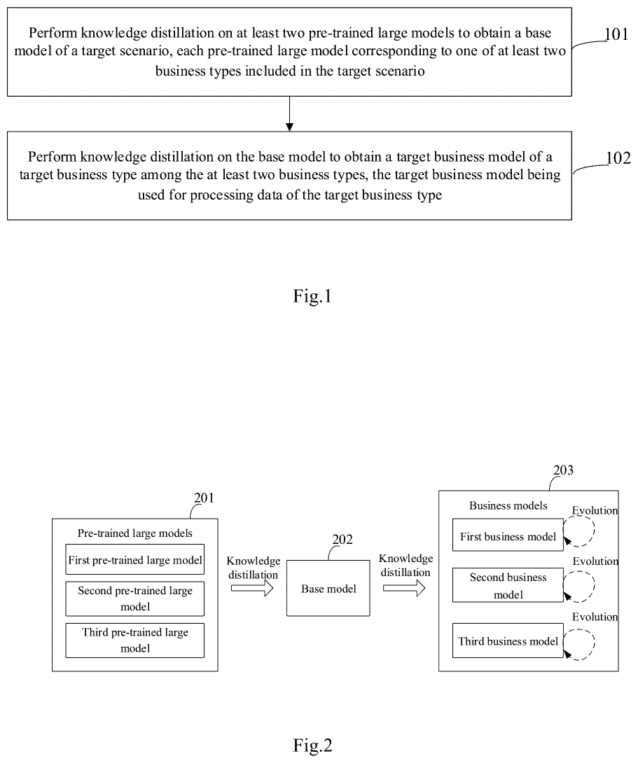

FIG. 2 is a schematic diagram of the application scenario for implementing embodiments of the present disclosure.

As shown in FIG. 2, this application scenario includes: pre-trained large models 201, a 202 of the target scenario, and business models 203 corresponding base model to each business type.

A large model library can be pre-built to store available pre-trained large models for selection. When targeting a certain target scenario, multiple pre-trained models can be selected based on the various business types included in the target scenario.

In this embodiment, taking an enterprise office scenario as an example of the target scenario, assuming that it involves multiple business types, including: customer service dialogue, enterprise document processing, and intelligent recommendations, pre-trained models suitable for the above three business types can be selected from the large model library. Assuming that the selected pre-trained models are represented as the first to third pre-trained models, this allows the base model of the target scenario to learn knowledge from multiple teacher models (pre-trained models), improving the accuracy, stability, and generalization capability of the base model. The business models corresponding to each business type are called the first, second, and third business models respectively.

The base model is obtained through knowledge distillation from pre-trained large models.

The business models, in their initial state, are obtained through knowledge distillation from the base model. Furthermore, in order to improve the performance of the business models (such as accuracy or stability), each business model can also perform evolution operations to achieve self-evolution.

The core concept of model evolution is continuous optimization and improvement of the model to adapt to new requirements or environmental changes. This process may involve improvements to the model structure and/or parameters. In this embodiment, the business model can execute evolution operations using preset evolution algorithms.

Based on the above application scenarios, the present disclosure provides the following embodiments.

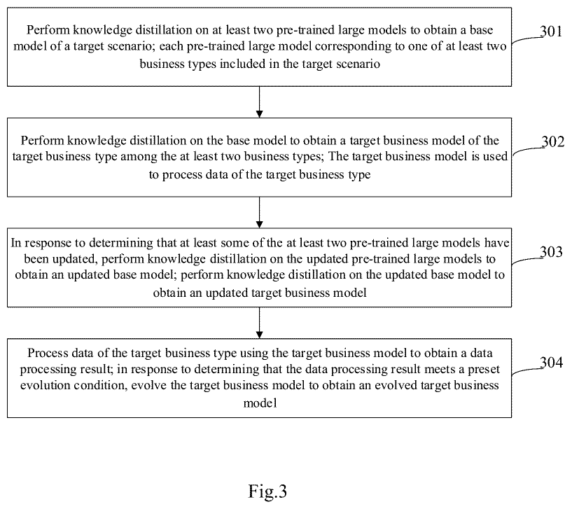

FIG. 3 is a schematic diagram according to the second embodiment of the present disclosure, which provides a method for generating a target business model based on large model. This method includes:

301: Performing knowledge distillation on at least two pre-trained large models to obtain a base model of a target scenario; each pre-trained large model corresponding to one of at least two business types included in the target scenario.

Specifically, each pre-trained model can be used to process a first training sample of the at least two business types to obtain a first output result; the base model is used to process the first training sample to obtain at least two second output results; each second output result corresponds to one business type; a first loss function is constructed based on the first output result and the second output results; the model parameters of the base model are adjusted based on the first loss function.

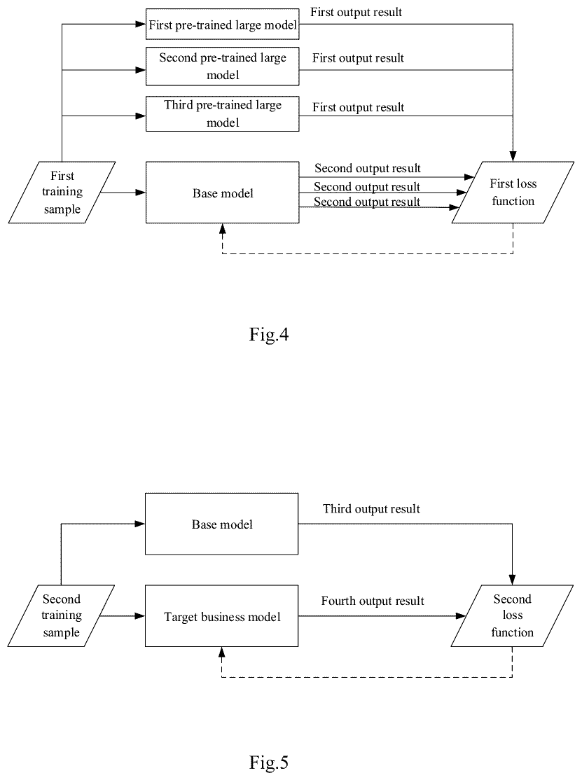

The knowledge distillation from the pre-trained large model to the base model can be referred to as the first stage of knowledge distillation. FIG. 4 is a schematic diagram of the first stage of knowledge distillation according to an embodiment of the present disclosure.

As shown in FIG. 4, the training sample used in the first stage of knowledge distillation is called the first training sample, which includes data from multiple business types involved in the target scenario.

For example, if the target scenario is an enterprise office scenario involving multiple business types, including: customer service dialogue, enterprise document processing, and intelligent recommendations, then data from these three business types needs to be collected as the first training sample.

Specifically, various types of business data can be collected from enterprise's log data to obtain the first training samples.

In addition, in order to improve data quality, the collected raw data can be preprocessed, and the preprocessed data can be used as training samples. Preprocessing includes removing sensitive data, removing garbled or improperly formatted data, semantic deduplication, and removing low-quality data (such as sentences that are too short or too long, or content lacking semantic richness), etc.

After obtaining the first training sample, the first training sample is input into each pre-trained large model and the base model to be trained. The output from the pre-trained large models is called the first output result, and the output from the base model is called the second output result.

Each pre-trained large model corresponds to one business type, so each pre-trained large model produces one first output result corresponding to one business type. For example, the first pre-trained large model outputs dialogue results, and the second pre-trained large model outputs document classification results, etc.

The base model can process data from multiple business types, thus producing multiple second output results which correspond to each business type respectively. For example, the base model can obtain both dialogue results and document classification results. Specifically, the base model can include multiple output layers, each of which is used to output results corresponding to a business type.

As shown in FIG. 4, taking three business types as an example, the pre-trained large models are respectively the first pre trained large model to the third pre trained large mode, with each pre-trained model outputting a first output result. The base model outputs three second output results.

Subsequently, the first loss function is constructed based on the first and second output results. Specifically, a loss function for each business type can be constructed using the first and second output results corresponding to each business type, and then the first loss function is constructed based on the loss function for each business type.

For example, if the first output results of the three pre-trained large models are represented as y11, y12, y13, and the second output results of the base model are represented as p21, p22, p23, assuming y11 and p21 correspond to the same business type (e.g., both are dialogue results and the rest is similar), then loss1 can be constructed based on y11 and p21, loss2 based on y12 and p22, and loss3 based on y13 and p23. The first loss function is then obtained by directly adding or weighted summing loss1, loss2, and loss3.

After obtaining the first loss function, algorithms like backpropagation can be used to adjust the parameters of the base model based on the first loss function until a preset ending condition is met. The base model that meets the ending condition will be used as the final base model.

In this embodiment, the first loss function is constructed based on the first output result of each pre-trained large model and the second output result of the corresponding business type output of the base model. By adjusting the parameters of the base model using the first loss function, the base model can accurately learn knowledge from each pre-trained large model without needing to understand the internal structure of the pre trained large model, thus efficiently and accurately generating the base model.

302: Performing knowledge distillation on the base model to obtain a target business model of the target business type among the at least two business types; The target business model is used to process data of the target business type.

If the target scenario includes three business types and a business model of the first business type is needed, then knowledge distillation can be performed on the base model to obtain the first business model.

Specifically, the base model can be used to process a second training sample to obtain a third output result; The second training sample includes: data of the target business type; The target business model is used to process the second training sample to obtain a fourth output result; A second loss function is constructed based on the third and fourth output results; The parameters of the target business model is adjusted based on the second loss function.

In this method, the knowledge distillation from the base model to the business model can be referred to as the second-stage of knowledge distillation. FIG. 5 is a schematic diagram of the second stage of knowledge distillation provided according to an embodiment of the present disclosure.

As shown in FIG. 5, the training sample used in the second stage of knowledge distillation is called the second training sample, which includes data of the target business type.

For example, if the target scenario is an enterprise office scenario involving multiple business types such as customer service dialogue, enterprise document processing, and intelligent recommendations, assuming the target business type is customer service dialogue, then data from this business type needs to be collected as the second training sample.

Specifically, data for the required business type can be collected from log data of the enterprise to obtain the second training sample.

In addition, in order to improve data quality, the collected raw data can be preprocessed, and the preprocessed data can be used as training samples. Preprocessing may include removing sensitive data, removing garbled or improperly formatted data, semantic deduplication, removing low-quality data (such as sentences that are too short or too long, or data of insufficient semantic content), etc.

As shown in FIG. 5, after obtaining the second training sample, the second training sample is input into the base model obtained from the first stage of knowledge distillation and the business model to be trained (the target business model). The output of the base model is called the third output result, and the output of the target business model is called the fourth output result.

Subsequently, a second loss function is constructed based on the third and fourth output results. Specifically, the third output result can be selected from the output of the base model corresponding to the target business type. For example, if the base model has three output layers, each corresponding to one business type, and assuming the target business type is the first business type, then the output of the output layer corresponding to the first business type can be selected as the third output result. Each business model corresponds to a business type, so each target business model can output a fourth output result corresponding to the business type. Thus, the third and fourth output results correspond to the same business type (e.g., both are dialogue results), allowing the second loss function corresponding to each target business model to be constructed based on the third and fourth results, and the corresponding target business model can be adjusted according to the second loss function, such as adjusting the business model of the customer service dialogue.

The specific adjustment process can include: using the second loss function and algorithms such as backpropagation to adjust the model parameters of the target business model until a preset ending condition is met, and using the target business model that meets the ending condition as the final target business model.

In this embodiment, the second loss function is constructed based on the third output result of the base model and the fourth output result of the target business model. By adjusting the parameters of the target business model using the second loss function, the target business model can accurately learn knowledge from the base model without needing to understand its internal structure, thus efficiently and accurately generating the target business model.

The above process involves generating both the base model and the target business model, and in some cases, updates can also be made to the base model and the target business model.

This update process can be referred to as an evolution process.

Furthermore, for the base model, its evolution process is mainly based on performing knowledge distillation again with a new pre-trained large model to obtain an updated base model.

For business models, their evolution process mainly involves using preset evolution algorithms for self-evolution based on the inference results (data processing results) of the business model to obtain an updated business model.

Therefore, in some embodiments, it may also include:

303: In response to determining that at least some of the at least two pre-trained large models have been updated, performing knowledge distillation on the updated pre-trained large models to obtain an updated base model; performing knowledge distillation on the updated base model to obtain an updated target business model.

For example, if there are three pre-trained large models and at least one of them has been updated, then knowledge distillation can be performed again on these updated pre-trained large models, such as the first stage of knowledge distillation mentioned above, to obtain an updated base model.

Since the base model has been updated, knowledge distillation can be further performed again on the updated base model to obtain an updated target business model.

Furthermore, in the first stage, in order to reduce computational load, the update process can use the same first training sample. In this way, only the output results of the updated pre-trained large model need to be adjusted, while other output results remain unchanged, thereby reducing computational load and saving resources.

For example, referring to FIG. 4, assuming that only the first pre-trained large model has been updated, the first training sample can be input into the updated first pre-trained large model to obtain a new first output results of the first pre-trained large model, while the output results of the other pre-trained large models and the base model remain unchanged. The previously calculated results can be directly used without recalculation, thereby reducing computational load and saving resources.

In addition, after the base model has been updated, in the second stage, the same second training sample can also be used, so the previously calculated output results of the target business model can be directly used, thereby reducing computational load and saving resources.

In this embodiment, updating the base model based on updated pre-trained large model and updating the target business model based on the updated base model can achieve timely updates of the target business model and improve its accuracy.

304: Processing data of the target business type using the target business model to obtain a data processing result; in response to determining that the data processing result meets a preset evolution condition, evolving the target business model to obtain an evolved target business model.

In this embodiment, after generating the target business model, it can be deployed, and then this target business model is used in the online process for data processing to obtain a data processing result. For example, using a customer service dialogue business model to execute customer service dialogue processes to obtain a customer service dialogue result.

After obtaining the data processing result, if the data processing result triggers an evolution operation, then the target business model will perform a self-evolution operation.

Specifically, an evolution condition can be preset, such as when the accuracy of the data processing result falls below a set certain threshold. At this time, the target business model can perform evolution operations according to a preset evolution algorithm, which includes processes for updating model parameters, enabling automatic updates (evolution) of the target business model based on the evolution algorithm, thus obtaining an evolved target business model.

Subsequently, the evolved target business model is used for subsequent data processing of the target business type.

In this embodiment, the target business model is evolved when the data processing result triggers the evolution operation, which can achieve timely updates of the target business model and improve its accuracy.

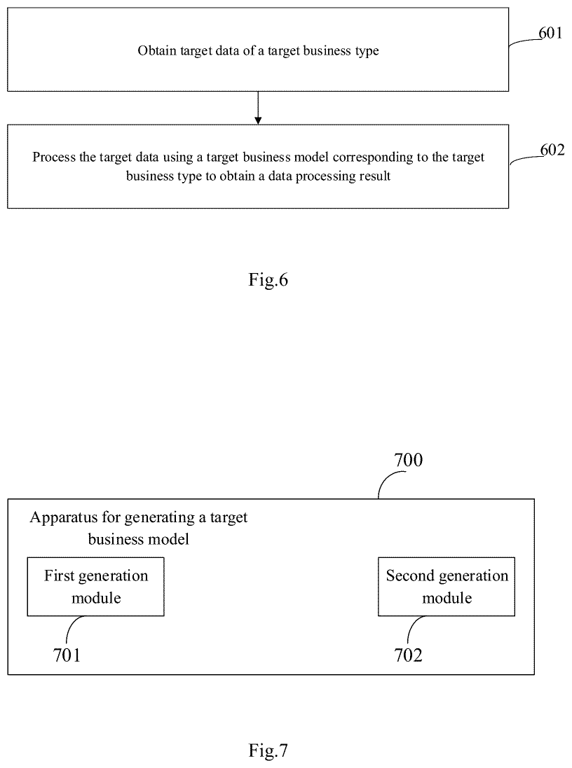

FIG. 6 is a schematic diagram according to the third embodiment of the present disclosure, which provides a method for data processing, including:

601: Obtaining target data of a target business type.

602: Processing the target data using a target business model corresponding to the target business type to obtain a data processing result.

In this embodiment, the target business model is generated using any of the methods shown in the above embodiments.

For example, for customer service dialogue data, a customer service dialogue model can be used for processing the data to obtain a customer service dialogue result.

In this embodiment, since the target business model is obtained through knowledge distillation, it is smaller in scale, and can reduce resource usage and improve processing efficiency; Since the target business model has the advantage of high accuracy, it can improve the accuracy of data processing results based on this model.

FIG. 7 is a schematic diagram according to the fourth embodiment of the present disclosure, which provides an apparatus 700 for generating a target business model based on large model, including: a first generation module 701 and a second generation module 702.

The first generation module 701 is configured to perform knowledge distillation on at least two pre-trained large models to obtain a base model of a target scenario; each pre-trained large model corresponding to one of at least two business types included in the target scenario. The second generation module 702 is configured to perform knowledge distillation on the base model to obtain a target business model of a target business type among the at least two business types; the target business model being used for processing data of the target business type.

In this embodiment, by performing knowledge distillation on the pre-trained large models to obtain a base model of the target scenario, and then the target business model of the target business type is obtained by performing knowledge distillation on the base model, which can generate the target business model cost-effectively and efficiently. In addition, by performing knowledge distillation on multiple pre-trained large models to obtain the base model, with each pre-trained large model corresponding to a business type, the base model can learn knowledge from different business types, which improves the generalization capability and accuracy of the base model, and thereby improves the accuracy of the target business model.

In some embodiments, the first generation module 701 is further configured to:

Process a first training sample using each pre-trained large model to obtain a first output result; The first training sample includes: data from the at least two business types;

Process the first training sample using said base model to obtain at least two second output results; Each second output result corresponds to a business type;

Construct a first loss function based on the first output result and the second output result;

Adjust the model parameters of the base model based on the first loss function.

In this embodiment, the first loss function is constructed based on the first output result of each pre-trained large model and the second output result of the corresponding business type output of the base model. By adjusting the parameters of the base model using the first loss function, the base model can accurately learn knowledge from each pre-trained large model without needing to understand the internal structure of the pre-trained large models, thus efficiently and accurately generating the base model.

In some embodiments, said second generation module 702 is further configured to:

Process a second training sample using the base model to obtain a third output result; The second training sample includes: data of the target business type;

process the second training sample using the target business model to obtain a fourth output result;

Construct a second loss function based on the third output result and the fourth output result;

Adjust the model parameters of the target business model based on the second loss function.

In this embodiment, the second loss function is constructed based on the third output result of the base model and the fourth output result of the target business model. and adjusting the parameters of the target business model using the second loss function, the target business model can accurately learn knowledge from the base model without needing to understand the internal structure of the base model, thus efficiently and accurately generating the target business model.

In some embodiments, the apparatus 700 may also include:

A first update module, configured to respond to determining that at least some of the at least two pre-trained large models have been updated, perform knowledge distillation on the updated pre-trained large models to obtain an updated base model; perform knowledge distillation on the updated base model to obtain an updated target business model.

In this embodiment, updating the base model based on updated pre-trained large models and updating the target business model based on the updated base model can achieve timely updates of the target business model and improve its accuracy.

In some embodiments, the apparatus 700 may also include:

A second update module, configured to process data of the target business type using the target business model to obtain a data processing result; In response to determining that the data processing result meets a preset evolution condition, evolve the target business model to obtain an evolved target business model.

In this embodiment, the target business model is evolved when the data processing result triggers evolution operation, which can achieve timely updates of the target business model and improve its accuracy.

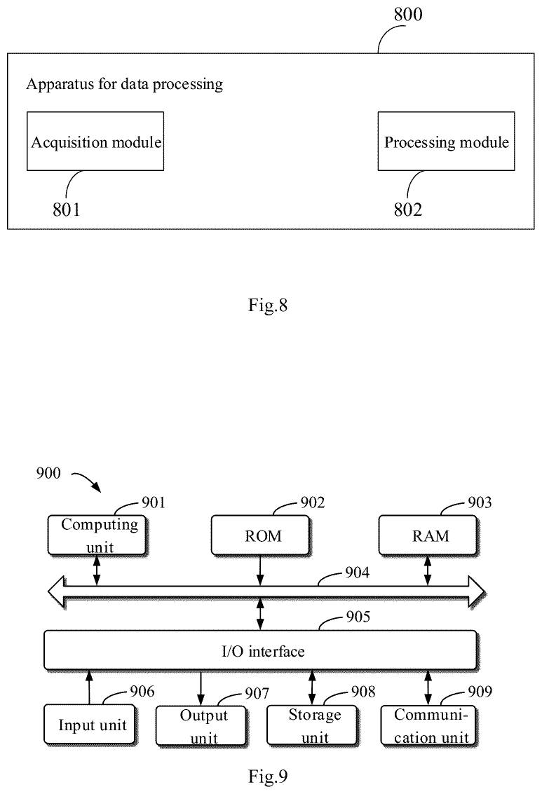

FIG. 8 is a schematic diagram according to the fifth embodiment of the present disclosure, which provides an apparatus 800 for data processing. The apparatus 800 includes: an acquisition module 801 and a processing module 802.

The acquisition module 801 is configured to obtain target data of a target business type; The processing module 802 is configured to process the target data using a target business model corresponding to the target business type to obtain a data processing result.

In this embodiment, the target business model is generated using any of the methods shown in the above embodiments.

For example, for customer service dialogue data, a customer service dialogue model can be used for processing the data to obtain a customer service dialogue result.

In this embodiment, since the target business model is obtained through knowledge distillation, it is smaller in scale, and can reduce resource usage and improve processing efficiency; Since the target business model has the advantage of high accuracy, it can improve the accuracy of data processing results based on this model.

It can be understood that in the embodiments of the present disclosure, identical or similar content in different embodiments can be cross-referenced.

It can be understood that in the embodiments of the present disclosure, terms like “first”, “second” etc. are only used for distinction and do not indicate importance level, temporal sequence, etc.

It can be understood that unless specifically stated otherwise, the temporal relationship between steps in the process flow is not limited.

In the technical solutions of the present disclosure, the collection, storage, use, processing, transmission, provision and disclosure of user personal information comply with relevant laws and regulations, and do not violate public order and good morals.

According to the embodiments of the present disclosure, the present disclosure also provides an electronic device, a readable storage medium and a computer program product.

FIG. 9 shows a schematic block diagram of an example electronic device 900 that can be used to implement embodiments of the present disclosure. Electronic device 900 is intended to represent various forms of digital computers, such as laptops, desktop computers, workstations, servers, blade servers, mainframes, and other suitable computers. The electronic device can also represent various forms of mobile devices, such as personal digital assistants, cellular phones, smartphones, wearable devices and other similar computing devices. The components shown here, their connections and relationships, and their functions are meant merely as examples, and are not intended to limit implementations of the present disclosure described and/or claimed in this document.

As shown in FIG. 9, electronic device 900 includes a computing unit 901, which can execute various appropriate actions and processes according to computer programs stored in read-only memory (ROM) 902 or loaded into random access memory (RAM) 903 from storage unit 908. Various programs and data needed for electronic device 900′s operation can also be stored in RAM 903. Computing unit 901, ROM 902, and RAM 903 are interconnected via bus 904. An input/output (I/O) interface 905 is also connected to bus 904.

Multiple components in electronic device 900 are connected to I/O interface 905, including: input unit 906, such as keyboard, mouse, etc.; output unit 907, such as various types of displays, speakers, etc.; storage unit 908, such as magnetic disks, optical discs, etc.; and communication unit 909, such as network cards, modems, wireless communication transceivers, etc. Communication unit 909 allows electronic device 900 to exchange information/data with other devices through computer networks such as the Internet and/or various telecommunication networks.

Computing unit 901 can be various general and/or specialized processing components with processing and computing capabilities. Some examples of computing unit 901 include but are not limited to central processing units (CPU), graphics processing units (GPU), various specialized artificial intelligence (AI) computing chips, various computing units running machine learning model algorithms, digital signal processors (DSP), and any suitable processors, controllers, microcontrollers, etc. Computing unit 901 executes the various methods and processes described above, such as model generation methods or data processing methods. For example, in some embodiments, the model generation method or data processing method can be implemented as computer software programs that are tangibly embodied in machine-readable media, such as storage unit 908. In some embodiments, part or all of the computer program can be loaded and/or installed onto electronic device 900 via ROM 902 and/or communication unit 909. When the computer program is loaded into RAM 903 and executed by computing unit 901, one or more steps of the model generation method or data processing method described above can be executed. Alternatively, in other embodiments, computing unit 901 can be configured to execute the model generation method or data processing method through any other suitable means (for example, through firmware).

Various implementations of the systems and techniques described in this document can be realized in digital electronic circuitry, integrated circuitry, field programmable gate arrays (FPGAs), application specific integrated circuits (ASICs), application specific standard products (ASSPs), system on chip (SoC), complex programmable logic devices (CPLDs), computer hardware, firmware, software, and/or combinations of these. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Program code for implementing methods of the present disclosure can be written in any combination of one or more programming languages. These program codes can be provided to processors or controllers of general-purpose computers, special-purpose computers, or other programmable task processing devices, such that when executed by the processor or controller, they implement the functions/operations specified in the flowcharts and/or block diagrams. The program code can execute entirely on the machine, partly on the machine, partly on the machine as a standalone software package and partly on a remote machine, or entirely on the remote machine or server.

In the context of the present disclosure, a machine-readable medium can be a tangible medium that can contain or store a program for use by or in connection with an instruction execution system, apparatus, or device. The machine-readable medium can be a machine-readable signal medium or a machine-readable storage medium. The machine-readable medium can include, but is not limited to, electronic, magnetic, optical, electromagnetic, infrared, or semiconductor systems, apparatus, or devices, or any suitable combination thereof. More specific examples of machine-readable storage media would include an electrical connection based on one or more wires, a portable computer diskette, a hard disk, random access memory (RAM), read-only memory (ROM), erasable programmable read-only memory (EPROM or Flash memory), optical fiber, portable compact disc read-only memory (CD-ROM), optical storage devices, magnetic storage devices, or any suitable combination thereof.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in computing systems that include back-end components (e.g., as data servers), or that include middleware components (e.g., application servers), or that include front-end components (e.g., user computers with graphical user interfaces or web browsers through which users can interact with implementations of the systems and techniques described here), or any combination of such back-end, middleware, or front-end components. The components of the system can be interconnected by any form or medium of digital data communication (e.g., a communication network). Examples of communication networks include local area network (LAN), wide area network (WAN), and the Internet.

The computer system can include clients and servers. A client and server are generally remote from each other and typically interact through a communication network. The relationship of client and server arises by virtue of computer programs running on the respective computers and having a client-server relationship to each other. The server can be a cloud server, also known as a cloud computing server or cloud host, which is a host product in the cloud computing service system, solving the difficulties in management and weak business scalability that exist in traditional physical hosts and VPS services (“Virtual Private Server” or “VPS” for short). The server can also be a distributed system server, or a server integrated with blockchain.

It should be understood that various forms of processes shown above can be used, with steps being reordered, added, or removed. For example, the steps recorded in the present disclosure can be executed in parallel or in sequence or in different orders, as long as they can achieve the desired results of the technical solutions disclosed in this document, which is not limited herein.

The above specific embodiments do not constitute limitations on the protection scope of the present disclosure. Those skilled in the art should understand that various modifications, combinations, sub-combinations and substitutions can be made according to design requirements and other factors. Any modifications, equivalent replacements, and improvements made within the spirit and principles of the present disclosure should be included within the protection scope of the present disclosure.

What is claimed is:

1. A method for generating a target business model based on large model, comprising:
performing knowledge distillation on at least two pre-trained large models to obtain a base model of a target scenario, each pre-trained large model corresponding to one of at least two business types included in the target scenario;
performing knowledge distillation on the base model to obtain a target business model of a target business type among the at least two business types, the target business model being used for processing data of the target business type.

2. The method according to claim 1, wherein performing knowledge distillation on at least two pre-trained large models to obtain a base model of a target scenario comprises:
processing a first training sample using each pre-trained large model to obtain a first output result, wherein the first training sample comprises: data from the at least two business types;
processing the first training sample using the base model to obtain at least two second output results, wherein each second output result corresponds to a business type;
constructing a first loss function based on the first output results and the second output results;
adjusting model parameters of the base model based on the first loss function.

3. The method according to claim 1, wherein performing knowledge distillation on the base model to obtain a target business model of a target business type among the at least two business types comprises:
processing a second training datasets using the base model to obtain a third output results, wherein the second training sample comprises data of the target business type;
processing the second training sample using the target business model to obtain a fourth output result;
constructing a second loss function based on the third output result and the fourth output result;
adjusting model parameters of the target business model based on the second loss function.

4. The method according to claim 1, further comprising:
in response to determining that at least some of the pre-trained large models have been updated, performing knowledge distillation on the updated pre-trained large models to obtain an updated base model;
performing knowledge distillation on the updated base model to obtain an updated target business model.

5. The method according to claim 1, further comprising:
processing data of the target business type using the target business model to obtain a data processing result;
in response to determining that the data processing result meets a preset evolution condition, evolving the target business model to obtain an evolved target business model.

6. A data processing method, comprising:
obtaining target data of a target business type;
processing the target data using a target business model corresponding to the target business type to obtain a processing result;
wherein the target business model is generated using the method according to claim 1.

7. An electronic device, comprising:
at least one processor; and
a memory communicatively connected with the at least one processor;
wherein the memory stores instructions executable by the at least one processor, and the instructions are executed by the at least one processor to enable the at least one processor to perform a method for generating a target business model based on large model, wherein the method for generating a target business model based on large model comprises:
performing knowledge distillation on at least two pre-trained large models to obtain a base model of a target scenario, each pre-trained large model corresponding to one of at least two business types included in the target scenario;
performing knowledge distillation on the base model to obtain a target business model of a target business type among the at least two business types, the target business model being used for processing data of the target business type.

8. The electronic device according to claim 7, wherein performing knowledge distillation on at least two pre-trained large models to obtain a base model of a target scenario comprises:
processing a first training sample using each pre-trained large model to obtain a first output, wherein the first training sample comprises data from the at least two business types;
processing the first training sample using the base model to obtain at least two second output results, wherein each second output result corresponds to a business type;
constructing a first loss function based on the first output result and the second output results;
adjusting model parameters of the base model based on the first loss function.

9. The electronic device according to claim 7, wherein performing knowledge distillation on the base model to obtain a target business model of a target business type among the at least two business types comprises:
processing a second training sample using the base model to obtain a third output result, wherein the second training sample comprise data of the target business type;
processing the second training sample using the target business model to obtain a fourth output result;
constructing a second loss function based on the third output result and the fourth output result;
adjusting model parameters of the target business model based on the second loss function.

10. The electronic device according to claim 7, further comprising:
in response to determining that at least some of the pre-trained large models have been updated, performing knowledge distillation on the updated pre-trained large models to obtain an updated base model, and performing knowledge distillation on the updated base model to obtain an updated target business model.

11. The electronic device according to claim 7, further comprising:
processing data of the target business type using the target business model to obtain a data processing result, and in response to determining that the data processing result meets a preset evolution condition, evolving the target business model to obtain an evolved target business model.

12. A non-transitory computer readable storage medium with computer instructions stored thereon, wherein the computer instructions are used for causing a method for generating a target business model based on large model, wherein the method for generating a target business model based on large model comprises:
performing knowledge distillation on at least two pre-trained large models to obtain a base model of a target scenario, each pre-trained large model corresponding to one of at least two business types included in the target scenario;
performing knowledge distillation on the base model to obtain a target business model of a target business type among the at least two business types, the target business model being used for processing data of the target business type.

13. The non-transitory computer readable storage medium according to claim 12, wherein performing knowledge distillation on at least two pre-trained large models to obtain a base model of a target scenario comprises:
processing a first training sample using each pre-trained large model to obtain a first output result, wherein the first training sample comprises: data from the at least two business types;
processing the first training sample using the base model to obtain at least two second output results, wherein each second output result corresponds to a business type;
constructing a first loss function based on the first output results and the second output results;
adjusting model parameters of the base model based on the first loss function.

14. The non-transitory computer readable storage medium according to claim 12, wherein performing knowledge distillation on the base model to obtain a target business model of a target business type among the at least two business types comprises:
processing a second training datasets using the base model to obtain a third output results, wherein the second training sample comprises data of the target business type;
processing the second training sample using the target business model to obtain a fourth output result;
constructing a second loss function based on the third output result and the fourth output result;
adjusting model parameters of the target business model based on the second loss function.

15. The non-transitory computer readable storage medium according to claim 12, further comprising:
in response to determining that at least some of the pre-trained large models have been updated, performing knowledge distillation on the updated pre-trained large models to obtain an updated base model;
performing knowledge distillation on the updated base model to obtain an updated target business model.

16. The non-transitory computer readable storage medium according to claim 12, further comprising:
processing data of the target business type using the target business model to obtain a data processing result;
in response to determining that the data processing result meets a preset evolution condition, evolving the target business model to obtain an evolved target business model.
